(19) United States
(12) Patent Application Publication
(10) Pub. No.: US 2009/0028733 A1
(43) Pub. Date: Jan. 29, 2009

(54) Compressor Valve Plate Assembly with Integrated Gasket

(75) Inventor: Jeffrey A. Duwel, Plymouth, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/782,943

(22) Filed: Jul. 25, 2007

(51) Int. Cl. F04B 39/10; B21D 51/16; F16K 15/14

(52) U.S. Cl. 417/546; 137/855; 29/890.132

(57) ABSTRACT

A valve plate assembly is provided including a plastic plate having a plurality of apertures therethrough, including at least one suction passage and at least one exhaust passage. A suction reed valve is disposed over the suction passage and an exhaust reed valve is disposed over the exhaust passage. A cylinder gasket is molded to a first side of the plastic plate and is adapted to seal around a cylinder of a cylinder housing. The cylinder gasket is recessed in a groove in the plastic plate. An end cap gasket is molded to a second side of the plastic plate and is adapted to seal against an end cap of a compressor. The end cap gasket is recessed in a groove in a second side of the plastic plate. The reed valves contact the plastic plate and are, therefore, quieter than a reed valve that is operated against a metal plate. The integration of the gasket into the recessed grooves of the plastic valve plate eliminates potential leak paths that exist with current designs. The use of a plastic valve plate also greatly reduces the weight and cost of the valve plate assembly. The valve plate assembly also provides an assembly which can be shipped to a customer in one piece for easier handling and installation.

### FIELD

The present disclosure relates to valve plates for a compressor and more particularly to a valve plate assembly with an integrated gasket and reed valves.

### BACKGROUND

The statements in this section merely provide background information related to the present disclosure and may not constitute prior art.

With reference to FIGS. 3 and 4, a compressor 10 is schematically shown to illustrate the operation of a valve plate 12 within a compressor. The compressor 10 includes a cylinder housing 14 and an end cap housing 16. The valve plate 12 is disposed between the cylinder housing 14 and end cap housing 16. The valve plate 12 includes a suction passage 18 and an exhaust passage 20 extending therethrough and includes a suction reed valve 22 disposed on the cylinder side of the valve plate 12 for closing the suction passage 18 and an exhaust reed valve 24 disposed on the end cap housing side of the valve plate 12 for closing the exhaust passage 20.

A piston 26 is disposed in the cylinder housing 14. During an intake stroke, the piston 26 moves in an upward direction, as illustrated in FIG. 3, causing suction air to be pulled through suction passage 18 thereby causing the suction reed valve 22 to open to allow gases to be drawn into the cylinder housing 14. During the exhaust stroke, the piston 26 moves downward, as illustrated in FIG. 4, causing compression of the gases within the cylinder 14. The exhaust reed valve 24 opens, as illustrated in FIG. 4, to allow the compressed exhaust gases to pass through the exhaust passage 20 in the valve plate 12.

In current compressor systems, the valve plate assembly typically includes a valve plate having suction and exhaust passages therethrough, a suction reed valve plate, a discharge reed valve plate are sandwiched on opposite sides of the valve plate, and suction and discharge gaskets are disposed on the outside thereof. The five-piece assembly requires that the components be properly aligned during installation and that the gaskets on each side be appropriately loaded in order to ensure a sealed relationship with the cylinder housing and end cap housing. The current designs are expensive to manufacture, heavy, complex in design, provide potential leak paths, and are noisy in operation. Accordingly, it is desirable in the compressor art to provide an improved valve plate design that is less expensive, lighter in weight, simple to assemble, provides improved leakage characteristics and is quieter in operation.

### SUMMARY

According to the present disclosure, a valve plate assembly is provided including a plastic plate having a plurality of apertures therethrough, including at least one suction passage and at least one exhaust passage. A suction reed valve is disposed over the suction passage and an exhaust reed valve is disposed over the exhaust passage. A cylinder gasket is molded to a first side of the plastic plate and is adapted to seal around a cylinder of a cylinder housing. The cylinder gasket is recessed in a groove in the plastic plate. An end cap gasket is molded to a second side of the plastic plate and is adapted to seal against an end cap of a compressor. The end cap gasket is recessed in a groove in a second side of the plastic plate.

With the design of the present disclosure, the reed valves contact the plastic plate and are, therefore, quieter than a reed valve that is operated against a metal plate. The integration of the gasket into the recessed grooves of the plastic valve plate eliminates potential leak paths that exist with current designs. The use of a plastic valve plate also greatly reduces the weight and cost of the valve plate assembly. The valve plate assembly of the present disclosure also provides an assembly which can be shipped to a customer in one piece for easier handling and installation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a valve plate assembly according to the principles of the present disclosure;

FIG. 2 is a bottom perspective view of the valve plate assembly shown in FIG. 1;

FIG. 3 is a schematic illustration of a piston-type compressor during an intake stroke and incorporating a valve plate for purposes of illustrating the functionality of the valve plate assembly of the present disclosure;

FIG. 4 is a schematic view similar to FIG. 3 illustrating the compressor in an exhaust stroke;

FIG. 5 is a bottom perspective view of the valve plate with the suction reed valves molded thereto;

FIG. 6 is a top perspective view of the valve plate according to the principles of the present disclosure;

FIG. 7 is a top perspective view of the valve plate with the exhaust reed valve assembled thereto;

FIG. 8 is a top plan view of a stamping utilized for making the exhaust reed valve according to the principles of the present disclosure;

FIG. 9 is a perspective view of an assembled reed valve and reed valve backer according to the principles of the present disclosure;

FIG. 10 is a perspective view of a rubber backing provided on the back of a reed valve backer according to the principles of the present disclosure;

FIG. 11 is a cross-sectional view illustrating the rubber backing engaging a stopper arm of the compressor end cap according to the principles of the present disclosure;

FIG. 12 is a cross-sectional view illustrating the integrated gasket formed in a recessed groove in the valve plate; and

FIG. 13 is a perspective view of an end cap housing having support posts for supporting the valve plate assembly.

### DETAILED DESCRIPTION

The following description is merely exemplary in nature and is not intended to limit the present disclosure, application, or uses. It should be understood that throughout the drawings, corresponding reference numerals indicate like or corresponding parts and features.

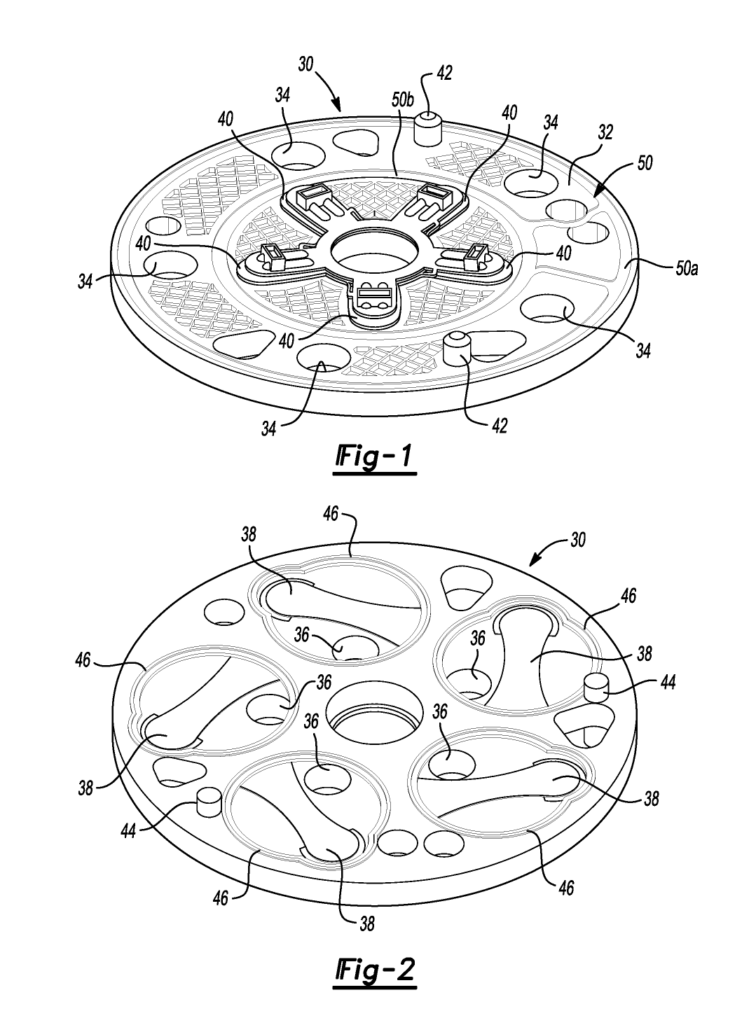

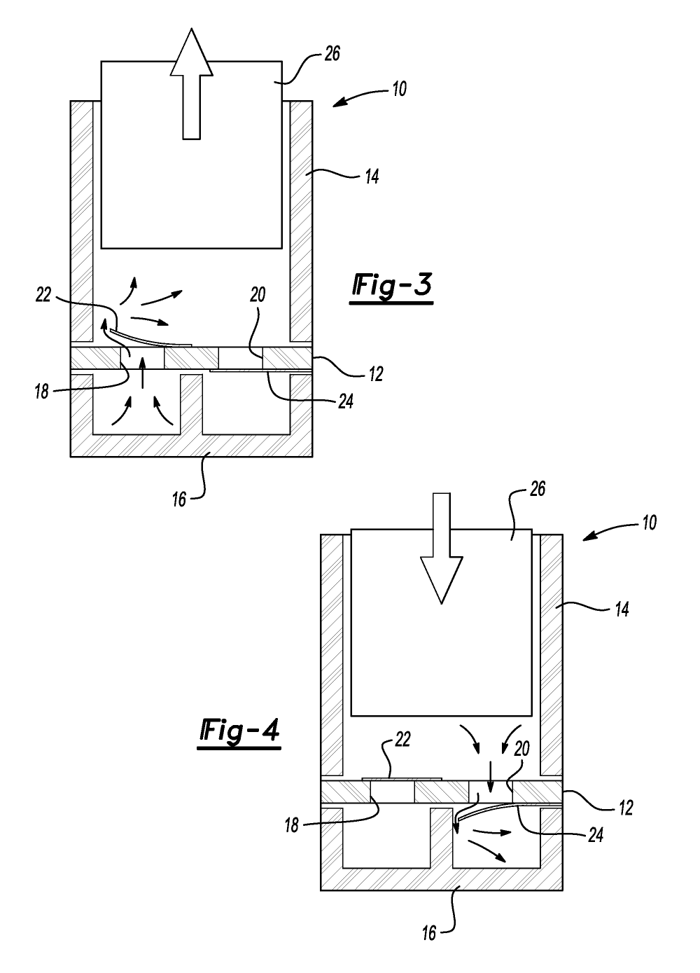

With reference to FIGS. 1-12, the valve plate assembly 30, according to the present disclosure, will now be described. The valve plate assembly 30 includes a plastic plate 32 that can be disk-shaped or have other shapes as desired. In order to prevent a creep problem due to high compressive bolt loads on the valve plate, the plastic plate 32 can be made from semi-crystalline thermoplastic like PPA or PPS or other plastic materials having high compressive strength and creep resistance. The plastic plate 32 is provided with a plurality of apertures therethrough including suction passages 34, as best illustrated in FIG. 1, and exhaust passages 36, as best illustrated in FIG. 2. As illustrated in FIG. 2, a plurality of suction reed valves 38 are provided in covering relationship over the suction passages 34. As illustrated in FIG. 1, a plurality of exhaust reed valves 40 are provided in covering relationship over the exhaust passages 36.

The plastic plate can include alignment pins 42, 44 on each side thereof which are designed to be received in corresponding bores provided in the cylinder housing and end cap of a compressor, respectively, to ensure proper alignment of the valve plate assembly 30. As illustrated in FIG. 2, the valve plate assembly 30 is provided with five cylinder gaskets 46 which are preferably received in recessed grooves 48 provided in the surface of the plastic plate 32. The recessed gasket 46 is best shown in FIG. 12.

The valve plate 30, as illustrated, is provided for a multi-cylinder compressor having five cylinders. It should be understood that other numbers of cylinders, including one or more cylinders, can be utilized with the valve plate assembly 30 of the present disclosure. The cylinder gaskets 46 define a sealed relationship around an individual pair of suction and exhaust passages, respectively. As illustrated in FIG. 1, the plastic plate 32 is also provided with an end cap gasket 50 that can be molded into a recessed groove 52 provided in the plastic plate 32 in the same manner as the cylinder gaskets 46 shown in FIG. 12. The end plate gasket 50 includes a first gasket portion 50A that surrounds a perimeter of the plastic plate 32 and a second gasket portion 50B that is disposed intermediately between the exhaust passages 36 and suction passages 34 to separate the exhaust passages 36 from the suction passages 34.

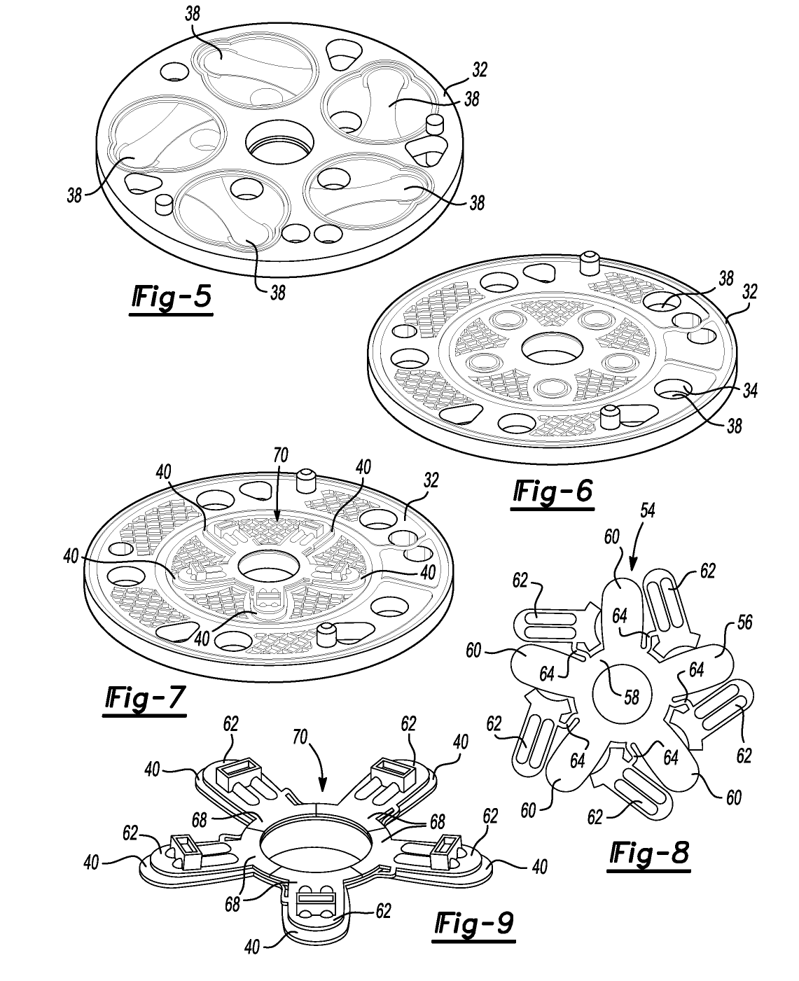

With reference to FIG. 5, the suction reed valves 38 are shown each independently integrally molded into the plastic plate 32. Alternatively, the suction reed valves 38 can be secured by vibration welding, heat staking, secured to molded posts, by allowing the clamping force of the final assembly to control placement, or by other known securement methods. FIG. 6 provides a top perspective view of the plastic plate 32 with the integrally molded suction reed valve 38 being visible within the suction passages 34.

FIG. 7 shows the plastic plate 32 with the reed valves 40 assembled thereto. The reed valves 40 can be formed as a single stamping 54, as illustrated in FIG. 8. The stamping 54 can include a star-shaped reed valve base portion 56 having a hub portion 58 and a plurality of radially extending flaps 60 extending from the hub portion 58. Additionally, valve backers 62 can be formed with the stamping 54 in order to conserve material. The valve backers 62 can be connected to the hub portion 58 by tethers 64 which, during the stamping operation, can be bent/formed in such a way that the backers end up residing directly over each flap as shown in FIG. 9. As an alternative, the backers can be snapped free to allow the backers 62 to be assembled to each of the flaps 60. As illustrated in FIG. 9, the valve backers 62 have a hub portion 68 which overlap the hub 58 of the star-shaped body 56. The valve backer 62 can be adhered to the star-shaped body 56 or can be otherwise fastened thereto using other known attachment means. The reed valve assembly 70, as shown in FIG. 9, includes the five exhaust reed valves 40 for covering the corresponding five exhaust passages 36 in the plastic plate 32. It should be understood that the reed valve assembly 70 can be changed in design in order to provide the appropriate number of reed valves corresponding with a number of desired cylinders used in a single or multi-cylinder compressor. With reference to FIG. 7, it can be seen that the reed valve assembly 70 can be fastened to the plastic plate 32 such that the hub portion 58 is adhered to the plate 32.

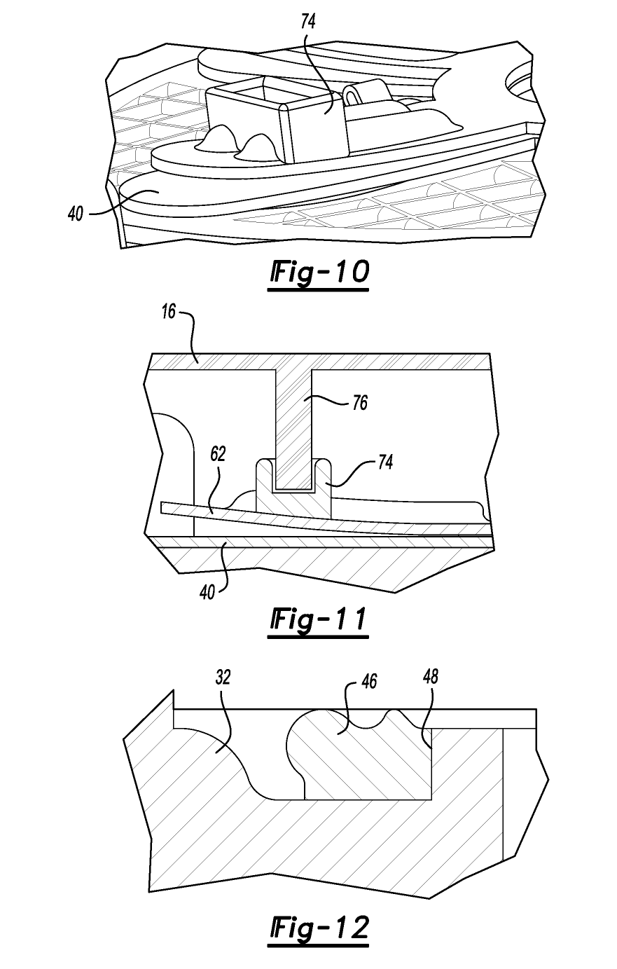

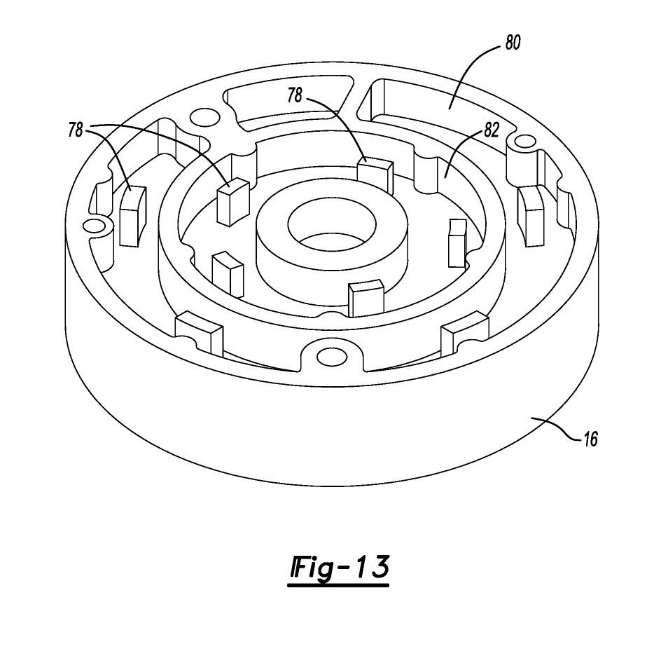

With reference to FIGS. 10 and 11, the reed valve backers 62 can also be provided with a rubber backing or bumper 74 that engages a post 76 which extends from the end cap housing 16, as illustrated in FIG. 11. The valve backer 62 limits the motion of the reed valve 40 relative to the exhaust passage and the bumpers 74 provide for smooth, quiet operation thereof. As an optional feature, in order to provide further support for the valve plate assembly 30, the end cap housing 16 can be provided with support posts 78 that engage the plastic plate 32 in order to support regions of high stress. The support posts 78 can reside within the suction channel 80 and/or discharge channel 82 of the end cap housing 16 depending upon where additional support may be desired.

With the valve plate assembly of the present disclosure, the use of a plastic main plate allows the reed valves and sealing gasket to be integrated therein so that the assembly can be shipped to the customer in one piece. In addition, the valve plate assembly of the present disclosure is less expensive, lighter in weight, simple in construction, quieter, and provides better sealing than current designs.

What is claimed is:

1. A valve plate assembly, comprising:
a plastic plate having a plurality of apertures therethrough including at least one suction passage and at least one exhaust passage; and
at least one suction reed valve and at least one exhaust reed valve disposed over corresponding ones of said suction passages and exhaust passages.

2. The valve plate assembly according to claim 1, wherein said at least one suction reed valve is integrally molded to said plastic plate.

3. The valve plate assembly according to claim 1, wherein said at least one exhaust reed valve is adhered to said plastic plate.

4. The valve plate assembly according to claim 1, further comprising a cylinder gasket molded to a first side of said plastic plate, said cylinder gasket being adapted to seal around a cylinder of a cylinder housing.

5. The valve plate assembly according to claim 4, wherein said cylinder gasket is recessed in a groove in said first side of said plastic plate.

6. The valve plate assembly according to claim 4, further comprising an end cap gasket molded to a second side of said plastic plate, said end cap gasket being adapted to seal against an end cap of a compressor.

7. The valve plate assembly according to claim 6, wherein said end cap gasket is recessed in a groove in said second side of said plastic plate.

8. The valve plate assembly according to claim 1, wherein said plastic plate is made from a semi-crystalline thermoplastic.

9. The valve plate assembly according to claim 1, further comprising an elastomeric bumper on a backer of said at least one exhaust reed valve.

10. The valve plate assembly according to claim 1, further comprising a cylinder gasket recessed in a groove in a first side of said plastic plate, said cylinder gasket being adapted to seal around a cylinder of a cylinder housing.

11. The valve plate assembly according to claim 10, further comprising an end cap gasket recessed in a groove in a second side of said plastic plate, said end cap gasket being adapted to seal against an end cap of a compressor.

12. A valve plate assembly for a multi-cylinder compressor, comprising:
a plastic plate having a plurality of pairs of apertures therethrough each of said pairs of apertures including a suction passage and an exhaust passage; and
a plurality of suction reed valves and a plurality of exhaust reed valves disposed over corresponding ones of said suction passages and exhaust passages.

13. The valve plate assembly according to claim 12, wherein said suction reed valves are integrally molded to said plastic plate.

14. The valve plate assembly according to claim 12, wherein said exhaust reed valves are integrally formed as a single stamping including a central hub portion connecting each of said exhaust reed valves.

15. The valve plate assembly according to claim 14, wherein said central hub portion is adhered to said plate.

16. The valve plate assembly according to claim 12, further comprising a plurality of cylinder gaskets molded to a first side of said plastic plate, said plurality of cylinder gaskets each being adapted to seal around a cylinder of a cylinder housing.

17. The valve plate assembly according to claim 16, wherein said plurality of cylinder gaskets are recessed in corresponding grooves in said first side of said plastic plate.

18. The valve plate assembly according to claim 16, further comprising an end cap gasket molded to a second side of said plastic plate, said end cap gasket being adapted to seal against an end cap of a compressor.

19. The valve plate assembly according to claim 18, wherein said end cap gasket is recessed in a groove in said second side of said plastic plate.

20. The valve plate assembly according to claim 12, wherein said plastic plate is made from a semi-crystaline thermoplastic.

21. The valve plate assembly according to claim 12, further comprising an elastomeric bumper on backers of each of said plurality of exhaust reed valves.

22. The valve plate assembly according to claim 12, further comprising a plurality of cylinder gaskets recessed in a groove in a first side of said plastic plate, said cylinder gaskets being adapted to seal around a corresponding cylinder of a cylinder housing.

23. The valve plate assembly according to claim 22, further comprising an end cap gasket recessed in a groove in a second side of said plastic plate, said end cap gasket being adapted to seal against an end cap of a compressor.

24. The valve plate assembly according to claim 23, wherein said end cap gasket includes a first gasket portion extending around a perimeter of said plastic plate, and a second gasket portion disposed between said plurality of suction passages and said exhaust passages.

25. The valve plate assembly according to claim 14, wherein said plurality of exhaust reed valves each include a reed backer secured thereto.

26. The valve plate assembly according to claim 12, wherein said suction reed valves are each independently secured to said plastic plate.

27. The valve plate assembly according to claim 26, wherein said suction reed valves are each molded to said plastic plate.

28. A method of making a valve plate assembly, comprising:
molding a plastic plate having a plurality of apertures therethrough including at least one suction passage and at least one exhaust passage, at least one suction reed valve being secured over said at least one suction passage;
fastening at least one exhaust reed valve over said at least one exhaust passage; and
molding a cylinder gasket to a first side of said plastic plate.

29. The method according to claim 28, further comprising molding an end cap gasket to a second side of said plastic plate.

31. The method according to claim 29, wherein said cylinder gasket and said end cap gasket are disposed in recessed grooves in said plastic plate.

32. The method according to claim 28, wherein said plastic plate is made from a semi-crystalline thermoplastic.

33. The method according to claim 28, further comprising fastening an elastomeric backer to said exhaust valve.

34. A method of making a reed valve assembly, comprising:
stamping a metal sheet to form a central hub portion, a plurality of valve members extending from said central hub, and a plurality of valve backers integrally formed with the central hub portion and the plurality of valve members.

34. The method according to claim 33, wherein said plurality of valve backers are each folded over a respective one of said plurality of valve members.

36. A multi-cylinder compressor comprising:
a cylinder housing;
an end cap housing; and
a valve plate assembly disposed between said cylinder housing and said end cap housing and including a plastic plate having a plurality of apertures therethrough including at least one suction passage and at least one exhaust passage and at least one suction reed valve and at least one exhaust reed valve disposed over corresponding ones of said suction passages and exhaust passages, wherein said end cap housing includes at least one support post engaging a surface of said plastic plate.
